(19) United States
(12) Patent Application Publication
(10) Pub. No.: US 2002/0129084 A1
(43) Pub. Date: Sep. 12, 2002

(54) Data processing apparatus and recording medium

(75) Inventor: Katsuhisa Muramatsu, Kawasaki-shi (JP)

Correspondence Address: OLIFF & BERRIDGE, PLC, P.O. BOX 19928, ALEXANDRIA, VA, 22320, US

(73) Assignee: Nikon Corporation

(21) Appl. No.: 10/137,400

(22) Filed: May 3, 2002

Related U.S. Application Data
(63) Continuation of application No. 09/920,824, filed on Aug. 3, 2001, now abandoned.
Application No. 09/920,824 is a continuation of application No. 08/969,489, filed on Nov. 13, 1997, now abandoned.

(30) Foreign Application Priority Data
Apr. 9, 1997 (JP) 9-090458

(51) Int. Cl. G06F 9/00

(52) U.S. Cl. 709/102

(57) ABSTRACT

When performing gamma-compensation processing, contour adjustment processing and resolution conversion processing, in that order, for example, on prescribed picture image data, the addresses in a memory in which the functions for performing those processes are also stored in that order. The data processing apparatus can modify the order of processing in response to user inputs. A new processing order is created, and the picture image processing is carried out according to the modified order.

### INCORPORATION BY REFERENCE

The disclosure of the following priority application is herein incorporated by reference: Japanese Patent Application No. 9-090458, filed Apr. 9, 1997.

### BACKGROUND OF THE INVENTION

1. Field of Invention

The present invention relates to a data processing apparatus and a recording medium, and in particular, it relates to a data processing apparatus and a recording medium that has the ability to execute a plurality of types of processes in any order, by creating data in advance that has a predetermined processing order.

2. Description of Related Art

FIG. 13 is a block diagram showing an example of a picture image processing device of the prior art. An image processing component 2, which is part of the picture image processing device 1, records a program that performs various types of picture image processing, such as gamma-compensation processing, resolution conversion processing, contour adjustment processing, and the like. The image processing component then executes these picture image processes against picture image data that has been input through a scanner 5. A control component 3 is comprised of a CPU (central processing unit), a ROM (read only memory), and a RAM (random access memory). The operation of the picture image processing component 2 is controlled according to a predetermined control program that is stored in the ROM. Then, the picture image data that is processed through the picture image processing component 2 is written to a VRAM (video random access memory) 4.

The VRAM 4 stores the picture image data that is supplied by the control component 3. The stored picture image data is supplied to the display device 6 according to the control of the control component 3. The display device 6 displays the picture image that corresponds to the picture image data that is supplied from the VRAM 4.

The operation of a conventional picture image processing device is now described with reference to FIG. 14. First, in step S1, the inputting of the picture image is performed by the scanner 5 under the control of the control component 3. Next, the picture image data that corresponds to the input picture image is supplied to the picture image processing component 2. Then, in step S2, gamma compensation processing is performed which allows the adjustment of the gamma value of the picture image data that is supplied to the picture image processing component 2.

Next, in step S3, the resolution of the picture image is converted according to the size of the screen of the display device 6, so that it can be displayed on the display device 6. Consequently, the size of the picture image is modified accordingly. In step S4, the contour adjustment processing is performed which adjusts the strength of the contour of the picture image. Then, in step S5, the picture image data that underwent the above picture image processing is supplied to the VRAM 4, and the corresponding picture image is displayed on the screen of the display device 6.

While inputting the picture image in step S1, the picture image is normally partitioned into several blocks (blocks E₁ through E₆), as shown in FIG. 15. The inputting is completed according to the block units, and the process shown in the above flow chart is executed repeatedly only for that number of blocks.

When performing a plurality of types of picture image processing on the picture image data, there are cases where the optimal order of processing does not exist. For example, when performing size reduction processing and contour adjustment processing on a picture image, the computation amount during the contour adjustment processing can be reduced by performing the contour adjustment processing after the size reduction processing. Similarly, when performing size enlarging and contour adjustment processing on a picture image, the amount of computation used for the contour adjustment processing can be reduced by performing the contour adjustment processing before the size enlarging.

In order to perform processing in an optimal order, picture image processing devices of the prior art are pre-programmed. At the time of processing, the optimal order is determined and recorded, and the processing of the picture image is performed according to the order that was recorded in advance.

FIG. 16 is an operational flow chart describing the order of execution for determining the optimal picture image processing method. In step S11, the picture image processing component 2 receives, under the control of the control component 3, a picture image from the scanner 5 according to the block units. Then, in step S12 the optimal processing method is determined and executed, as will be described hereafter with reference to FIG. 17. Next, in step S13, a determination is made as to whether the processes of step S11 and step S12 have been completed for all of the block unit of the picture image. If a determination is made that the aforementioned processes have not yet been completed for all of the block units, the program returns to step S11. Meanwhile, if a determination is made that the aforementioned processes have been completed for all of the blocks, then the process is complete.

FIG. 17 is an operational flow chart describing the specifics of the process which occurs in step S12 of FIG. 16. In step S21, a determination is made as to whether to perform the resolution conversion processing for the picture image data of the prescribed block that was received by the scanner 5. If a determination is made that the resolution conversion processing is to be performed, it proceeds to step S22. In step S22, a determination is made as to whether the aforementioned resolution conversion processing is the type of resolution conversion processing for enlarging a picture image. If a determination is made that it is a resolution conversion processing for enlarging a picture image, the process continues to step S23.

In step S23, a determination is made as to whether the contour adjustment processing is to be performed. If a determination is made that the contour adjustment processing is to be performed, then the program proceeds to step S24. In step S24, the gamma-compensation processing is executed first for the picture image data that has been entered. Then, in step S25, the contour adjustment processing is executed for processing the picture image data on which the gamma-compensation processing has been performed. In step S26, the resolution conversion processing is executed for the picture image data on which the contour adjustment processing has been performed. Here, the resolution conversion processing for enlarging a picture image is executed.

In step S23, if a determination is made that contour adjustment is not to be performed, the program proceeds to step S27, and executes gamma-compensation processing for the picture image that has been entered. Thereafter, in step S28, resolution conversion processing (enlarging) is executed for the picture image data on which gamma-compensation processing has been performed.

In step S22, if a determination is made that the resolution conversion processing is not for enlarging a picture image (i.e. it is a resolution conversion processing for reducing a picture image), then the program proceeds to step S29. In step S29, a determination is made as to whether the contour adjustment processing is to be performed. If a determination is made that the contour adjustment processing is to be performed, the program proceeds to step S30. In step S30, the gamma-compensation processing is executed for the picture image data that has been input. Next, in step S31, the resolution conversion processing (resolution conversion processing for reducing a picture image) is executed. Then, in step S32, the contour adjustment processing is executed.

If, in step S29, a determination is made that the contour adjustment processing is not to be performed, the program proceeds to step S33. In step S33, the gamma-compensation processing is executed for the picture image data that was entered. Then, in step S34, the resolution conversion processing (reduction) is executed.

In step S21, if a determination is made that the resolution conversion processing is not to be performed, the program proceeds to step S35. In step S35, a determination is made as to whether the contour adjustment processing is to be performed. If a determination is made that the contour adjustment processing is to be performed, the program proceeds to step S36. In step S36, the gamma-compensation processing is executed for the picture image data that has been entered. Then, in step S37, the contour adjustment processing is executed. In step S35, if a determination is made that the contour adjustment processing is not to be performed, the program proceeds to step S38. In step S38, the gamma-compensation processing is executed for the picture image data that was entered.

When the processes of any of either step S26, step S28, step S32, step S34, step S37 or step S38 are completed, the program then returns.

As described above, the picture image processing component 2 determines and executes the optimal processing method in relation to the picture image data that was entered.

When determining and executing the optimal processing method in a pre-programmed picture image processing device, it becomes difficult to change the order of processing. In order to make possible the execution of the processing according to any order of discretion, it becomes necessary to record the program in advance. Since the number of combinations of processes increases exponentially in conjunction with an increase of the types of processes, this creates a problem in that the program becomes very complex.

### SUMMARY OF THE INVENTION

The present invention, in consideration of the aforementioned conditions, makes possible the easy change of the order of processing when performing a series of data processing, and it further makes possible the efficient performance of processing.

The data processing apparatus according to one aspect of the invention includes a first storage means for storing one or more types of processes and a second storage means for storing information that corresponds to each of the one or more processes. The data processing apparatus also includes a setting means for setting the order for executing the processes, a replacement means for replacing the order for executing the processes, and an execution means for executing the processes in relation to input data, in the order set by the setting means.

In addition, the information stored in the second storage means may be the addresses in the first storage means where each process is stored.

In addition, the order for executing the processes that is set by the setting means may be indicated by the order in which the information is stored in the second storage means.

In addition, the order for executing the processes that is set by the setting means may be indicated by a number attached to the information stored in the second storage means.

In addition, an addition means (for example, an array management component) can be provided for newly adding information that corresponds to another process, onto the information that is stored in the second storage means.

The data processing apparatus according to another aspect of the invention includes a plurality of execution means where a plurality of types of processes are executed, a first storage means for storing first data that is the subject of execution for each process, and a second storage means for storing second data that is the execution result of each process. The apparatus also includes a supply means for supplying second data to the first storage means that is the result of one process and that is the prescribed object of some other process to which the second data is to be transmitted next. The supply means divides the second data when the data amount of the second data resulting from execution of the one process is larger than the data amount possible to be stored by the first storage means. The execution means sequentially executes the divided and supplied second data that is divided and supplied by way of the supply means.

In addition, the plurality of types of processes may be made to be processes that are performed on picture image data and/or audio sound data.

Another aspect of the invention includes a recording medium that records a computer-readable control program that is used by a data processing apparatus to provide a first storage means for storing one or more of types of processes, and a second storage means for storing information that corresponds to the one or more of processes. The program also establishes a setting means that sets the order for executing the processes that correspond to the information that is stored in the second storage means and a replacement means that replaces the order for executing the processes. The recording medium records a program that executes the process that corresponds to the information that is recorded in the second storage means for the data in an order that is set by the setting means.

### BRIEF DESCRIPTION OF THE DRAWINGS

The invention will be described in conjunction with the following drawings in which like reference numerals designate like elements and wherein:

FIG. 1 is a block diagram of a first embodiment of the present invention;

FIG. 2 is an operational flow chart used by the first embodiment of the invention;

FIG. 3 is an operational flow chart outlining in greater detail step S41 of FIG. 2;

FIG. 4 shows an example of the processing order data that is assigned to the array variable of the array management component;

FIG. 5 shows another example of the processing order data that is assigned to the array variable of the array management component;

FIG. 6 shows another example of the processing order data that is assigned to the array variable of the array management component;

FIG. 7 shows another example of the processing order data that is assigned to the array variable of the array management component;

FIG. 8 shows another example of the processing order data that is assigned to the array variable of the array management component;

FIG. 9 show another example of the processing order data that is assigned to the array variable of the array management component;

FIG. 10 is a flow chart describing a method that executes the functions according to the order set in the array variable;

FIG. 11 is a block diagram showing another composition example of the picture image processing component;

FIG. 12 is a block diagram showing yet another composition example of the picture image processing component;

FIG. 13 is a block diagram showing a composition example of a picture image processing device of the prior art;

FIG. 14 is an operational flow chart of a process performed by the FIG. 13 device;

FIG. 15 illustrates a picture image divided into plural blocks;

FIG. 16 is a flow chart describing a prior art method for determining the optimal order for performing the picture image processing; and

FIG. 17 is a flow chart that describes the order for determining and executing the optimal processing method for step S12 of FIG. 16.

### DETAILED DESCRIPTION OF PREFERRED EMBODIMENTS

Preferred embodiments of the present invention are described below in detail with reference to the drawings.

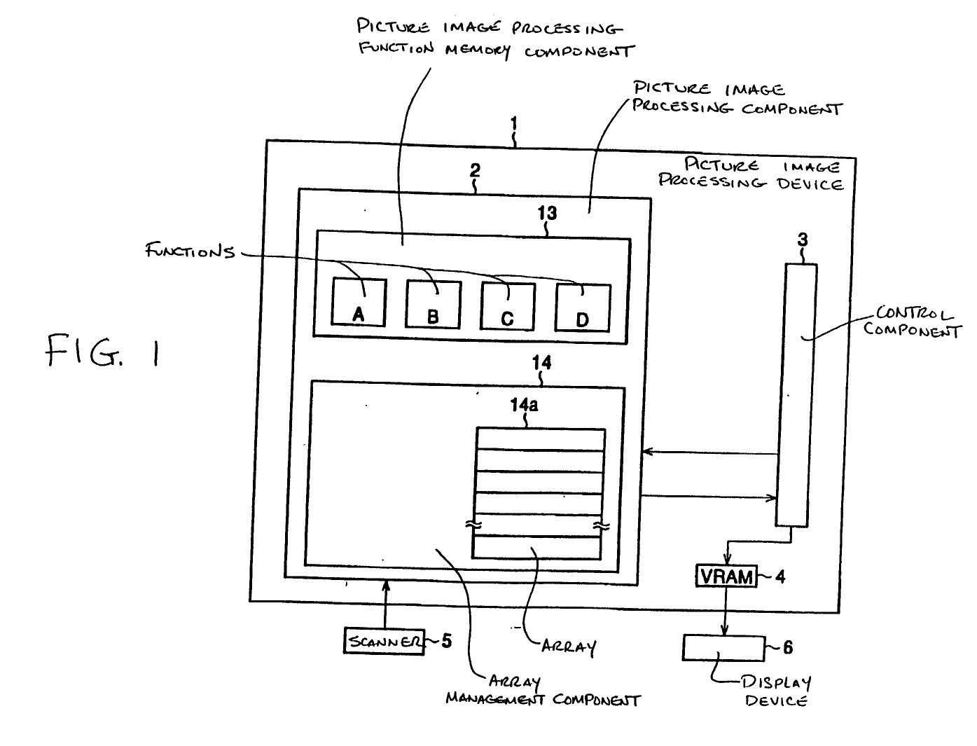

FIG. 1 is a block diagram of one embodiment of the present invention. The control component 3, which is part of the picture image processing device 1, includes a CPU (central processing unit), ROM (read only memory), and RAM (random access memory). Each component can be controlled according to the control program recorded in the ROM. A scanner 5 inputs picture image data. The picture image processing component 2 receives the picture image data from the scanner 5 according to a command from the control component 3 and executes the picture image processing for the picture image data that was received. A VRAM (video random access memory) 4 allows the data, such as a processing result, to be stored. A display device 6 allows the picture image that corresponds to the picture image data that was stored in the VRAM 4 to be displayed.

Furthermore, the picture image processing component 2 is composed of the picture image processing function memory component 13, which stores a plurality of mathematical processing functions for actually executing the picture image processing, and the array management component 14, which manages the execution order of each mathematical function. The address that designates the function that is stored in the picture image processing function memory component 13 is described in each element of the array variable 14a of the array management component 14. The function that corresponds to the aforementioned address order that is described in the array variable 14a is allowed to be executed.

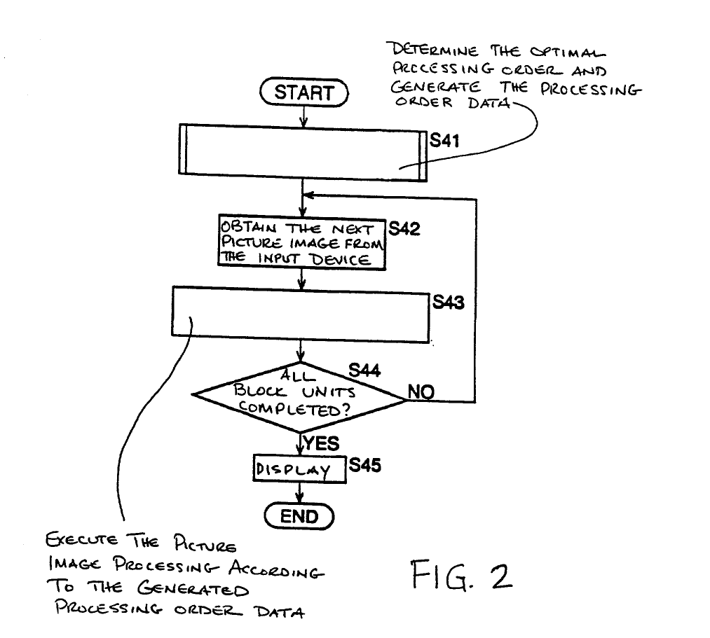

A description of the operation will be provided hereafter, with reference to the flow chart shown in FIG. 2. In step S41, the picture image processing component 2, following the instructions from the control component 3, determines the picture image processing functions that are to be executed for the picture image data that was entered and the optimal processing order for executing the picture image processing functions. The processing component then creates the data determined by the processing order (hereafter referred to as the processing order data). The address in the picture image processing function memory component 13, where the functions to be executed in order exist, is described on each array of the array management component 14.

In step S42, the picture image data is received in block units from the scanner 5 by way of the picture image processing component 2 and stored in a work buffer, which is not shown in the figure. Next, in step S43, the corresponding function is called and executed by way of the picture image processing function memory component 13, which follows the processing order data created in step S41.

In step S44, a determination is made as to whether the execution of the above process has been completed for all of the blocks. If a determination is made that the execution of the above process has not been completed for all of the blocks, the program returns to step S42. In step S44, if a determination is made that the execution of the above process has been completed for all the blocks, then the program proceeds to step S45. In step S45, the picture image data that underwent the picture image processing is supplied to the control component 3 by the picture image processing component 2. The control component 3 supplies the picture image data that was supplied from the picture image processing component 2 to the VRAM 4. The picture image data that was supplied to the VRAM 4 is supplied to the display device 6. Then, the picture image resulting from the picture image processing is displayed on the screen of the display device 6. Thereafter, the process is completed.

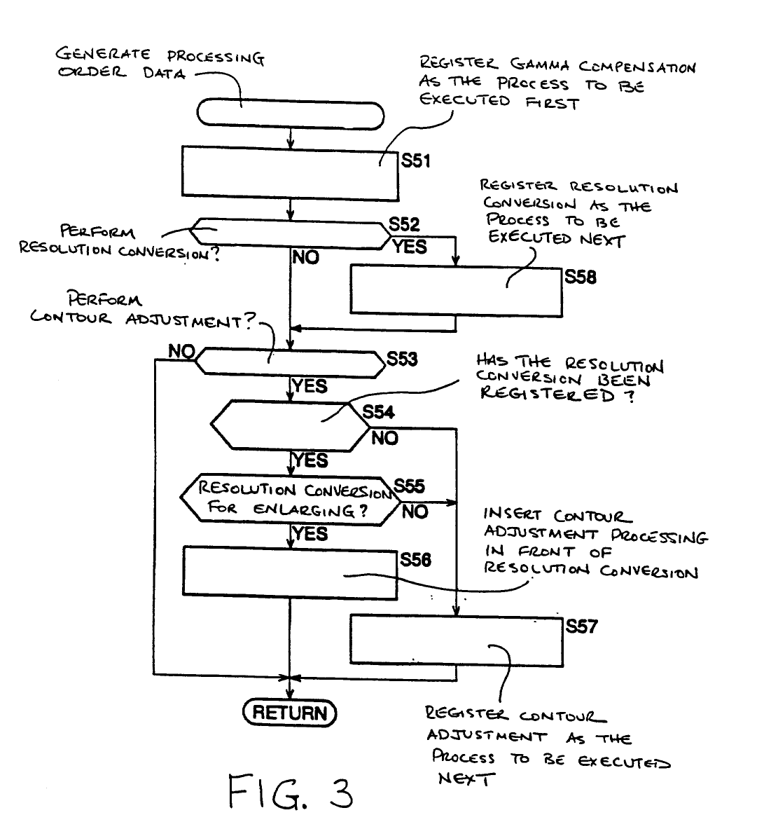

Next, the details of the process occurring in step S41 of FIG. 2 will be explained with reference to the flow chart of FIG. 3. In step S51, the gamma-compensation processing is registered as the picture image processing function that is first executed for the picture image data that is entered. In other words, the address of the function which executes the gamma-compensation processing is stored as the first element of the array variable 14a of the array management component 14.

Next, in step S52, a determination is made as to whether the resolution conversion processing is to be performed. If a determination is made that the resolution conversion processing is to be performed, then the program proceeds to step S58. In step S58, the function for executing the resolution conversion processing is registered. In other words, the address of the function for executing the resolution conversion processing is stored as the next element of the array variable 14a of the array management component 14. The program then proceeds to step S53. If a determination is made in step S52 that the resolution conversion processing is not to be performed, then the program proceeds to step S53, where a determination is made as to whether to perform the contour adjustment. If a determination is made that contour adjustment is to be performed, the program proceeds to step S54. In step S54, a determination is made as to whether the resolution conversion processing has been registered.

If a determination is made that the resolution conversion processing has been registered, then the program proceeds to step S55. In step S55, a determination is made as to whether the resolution conversion processing which has been registered is the type of conversion for enlarging a picture image. If a determination is made that it is the type of conversion for enlarging a picture image, then the program proceeds to step S56. In step S56, the function for executing the contour adjustment processing is inserted in front of (before) the function for performing the resolution conversion processing. In other words, the address for the function for executing the contour adjustment processing is inserted in front of the address for the function for performing the resolution conversion processing that is stored in the array variable 14a of the array management component 14.

In step S54, if a determination is made that the function for executing the resolution conversion processing has not been registered, and in step S55, if a determination is made that the resolution conversion processing which has been registered is not the type for enlarging a picture image, then the program proceeds to step S57. In step S57, the image resolution conversion processing is registered as the process to be executed following (after) the contour adjustment processing. In other words, the address for the function for executing the contour adjustment processing is stored as the next element of the array variable 14a of the array management component 14.

When the process which occurs in step S56 or the process which occurs in step S57 is completed, the program returns.

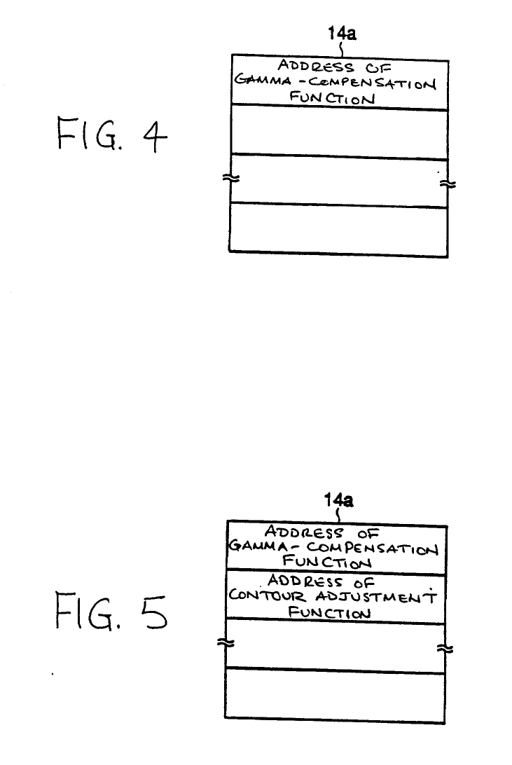

For example, in step S52, if a determination is made that resolution conversion processing is not to be performed, and then in step S53, if a determination is made that the contour adjustment processing is not to be performed, then, as shown in FIG. 4, the address of the function for executing the gamma-compensation processing is stored in the array variable 14a. Further, the picture image processing component 2, in step S43 of FIG. 2, calls the function for executing the gamma-compensation processing according to the address stored in the array variable 14a, and the gamma-compensation processing is performed for the picture image data that was entered from the scanner 5.

As another example, in step S52, if a determination is made that the resolution conversion processing is not to be performed, and in step S53, a determination is made that the contour adjustment processing is to be performed, and additionally in step S54, if a determination is made that the resolution conversion has not been registered, then, as shown in FIG. 5, the address of the function for executing the gamma-compensation processing as well as the address for the function for executing the contour adjustment processing are both stored in the array variable 14a. Furthermore, the picture image processing component 2, in step S43 of FIG. 2, calls the function for executing the gamma-compensation processing according to the address stored in the array variable 14a, and the gamma-compensation processing is performed for the picture image data that was entered from the scanner 5. Next, the function for performing the contour adjustment processing is called, and the contour adjustment processing is performed for the picture image data that underwent the gamma-compensation processing.

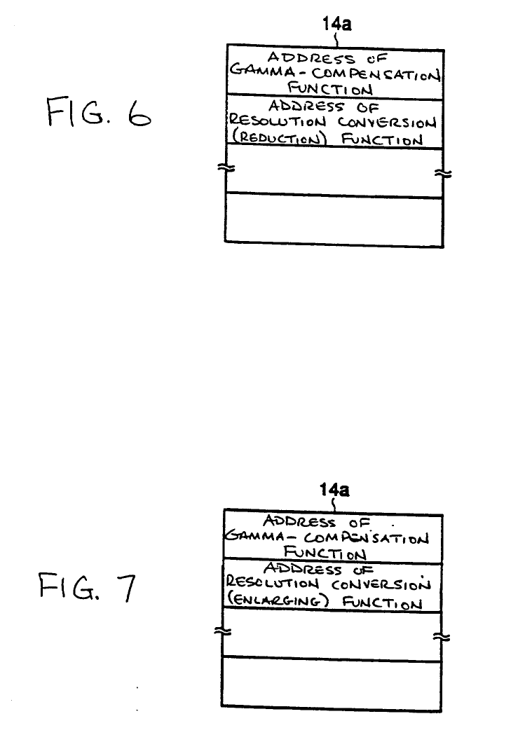

As another example, in step S52, if a determination is made that the resolution conversion processing is to be performed, and in step S53, if a determination is made that the contour adjustment processing is not to be performed, then, as shown in FIG. 6 or FIG. 7, the address for the function for executing the gamma-compensation processing and the address for the function for executing the resolution conversion processing (reduction or enlarging) are stored in the array variable 14a. Furthermore, the picture image processing component 2, in step S43 of FIG. 2, calls the function for executing the gamma-compensation processing according to the address stored in the array variable 14a, and the gamma-compensation processing is performed for the picture image data that was entered from the scanner 5. Next, the function for executing the resolution conversion processing (reduction or enlarging) is called, and the resolution conversion processing is performed for the picture image data that underwent the gamma-compensation processing.

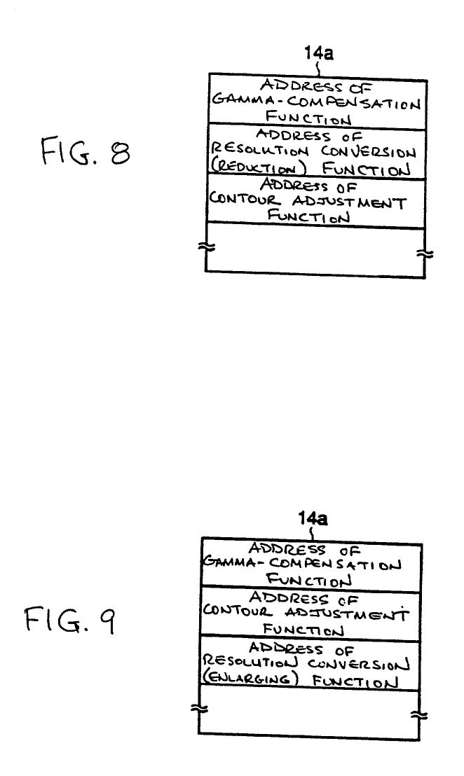

As another example, in step S52, if a determination is made that the resolution conversion processing is to be performed, and in step S53, a determination is made that the contour adjustment processing is to be performed, and in step S54, a determination is made that the resolution conversion has been registered, and further, in step S55, a determination is made that the resolution conversion which has been registered is not the type for enlarging a picture image, then, as shown in FIG. 8, the address for the function for executing the gamma-compensation processing, and the address for the function for executing the resolution conversion processing (reduction) and the address for the function for performing the contour adjustment processing are stored in the array variable 14a.

Then, the picture image processing component 2, in step S43 of FIG. 2, calls the function for executing the gamma-compensation processing according to the address that is stored in the array variable 14a, and the gamma-compensation processing is performed for the picture image data that was entered from the scanner 5. Next, the function for executing the resolution conversion processing (reduction) is called, and the resolution conversion processing (reduction) is performed for the picture image data that underwent the gamma-compensation processing. Finally, the function for executing the contour adjustment processing is called thereby allowing the contour adjustment processing to be performed for the picture image data that underwent the resolution conversion processing.

As another example, in step S52, if a determination is made that the resolution conversion processing is to be performed, and in step S53, a determination is made that the contour adjustment processing is to be performed, and in step S54, a determination is made that the resolution conversion has been registered, and then in step S55, a determination is made that the resolution conversion which has been registered is the type for enlarging a picture image, then, as shown in FIG. 9, the address for the function for executing the gamma-compensation processing, and the address for the function for performing the contour adjustment processing, and the address for the function for executing the resolution conversion processing (enlarging) are stored in the array variable 14a.

Then, the picture image processing component 2 calls the function for executing the gamma-compensation processing according to the address that is stored in the array variable 14a, and the gamma-compensation processing is performed for the picture image data that was entered from the scanner 5. Next, the contour adjustment processing is performed for the picture image data that underwent the gamma-compensation processing. Finally, the function for executing the resolution conversion processing (enlarging) is called, and the resolution conversion processing (enlarging) is performed for the picture image data that underwent contour adjustment processing.

After executing the picture image processing in accordance with any one of the above examples, the picture image resulting from the picture image processing is displayed on the screen of the display device 6.

As described above, by creating (and storing) the processing order data that is determined by the optimal processing order, it becomes possible to easily execute the desired processing in the optimal order. As a result of the above described embodiment of the invention, it is not necessary to store all of the patterns for performing the picture image processing, thereby reducing the overhead cost for performing the picture image processing.

In the embodiment described above, the address where a particular processing function is stored is assigned to (and stored in) the array variable 14a in the order that is desired for the functions to be executed. After reading the addresses in order, the corresponding functions are executed. However, the picture image processing device may also be configured so that the data indicating the order for executing the functions stored in the array variable 14a can be set one function at a time, thereby allowing the functions to be executed according to a prescribed order that is based on this data.

As shown in FIG. 9, the addresses for the function for performing the gamma-compensation processing, the function for performing the contour adjustment processing, and the function for performing the resolution conversion processing are stored in this order in the array variable 14a. Furthermore, the execution order of the function for performing the gamma-compensation processing is replaced by the variable G, and the execution order of the function for performing the contour adjustment is replaced by the variable R, and the execution order of the function for performing the resolution conversion is replaced by the variable K. Now, when substituting the value 1 for G, the value 2 for R, and the value 3 for K, the process, based upon the numerical values, is executed in the order of gamma-compensation, the contour adjustment, and the resolution conversion.

When desiring to execute the processes in a different order; for example, gamma-compensation, resolution conversion, and contour adjustment, it is not necessary to replace the address stored in the array. In order to achieve the different order, it is only necessary to reassign the variables to different processing functions. Substitute the value 1 for the variable G (the same as before), substitute the value 3 for the variable R and substitute the value 2 for the variable K. Therefore, by executing the corresponding functions in the order from the smallest numerical value set in the array variable 14a, the functions are executed according to the desired order.

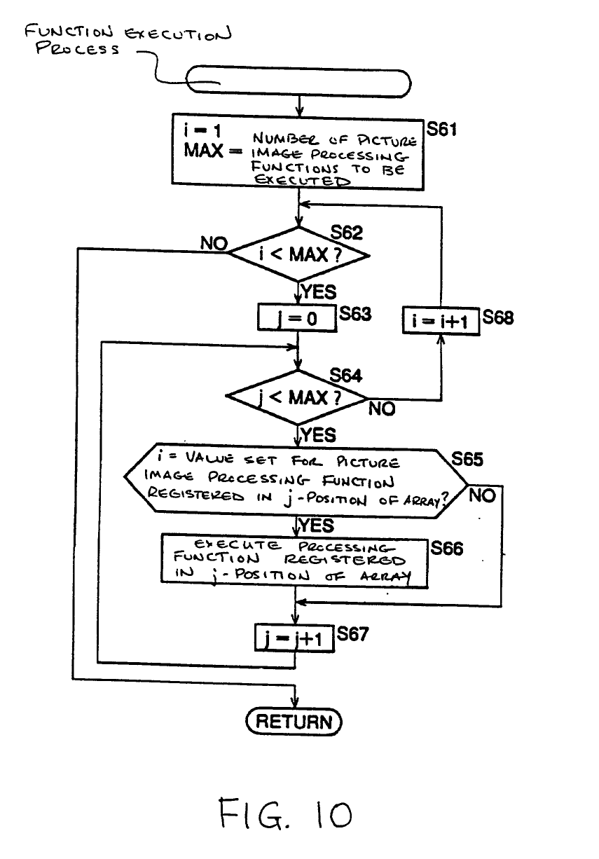

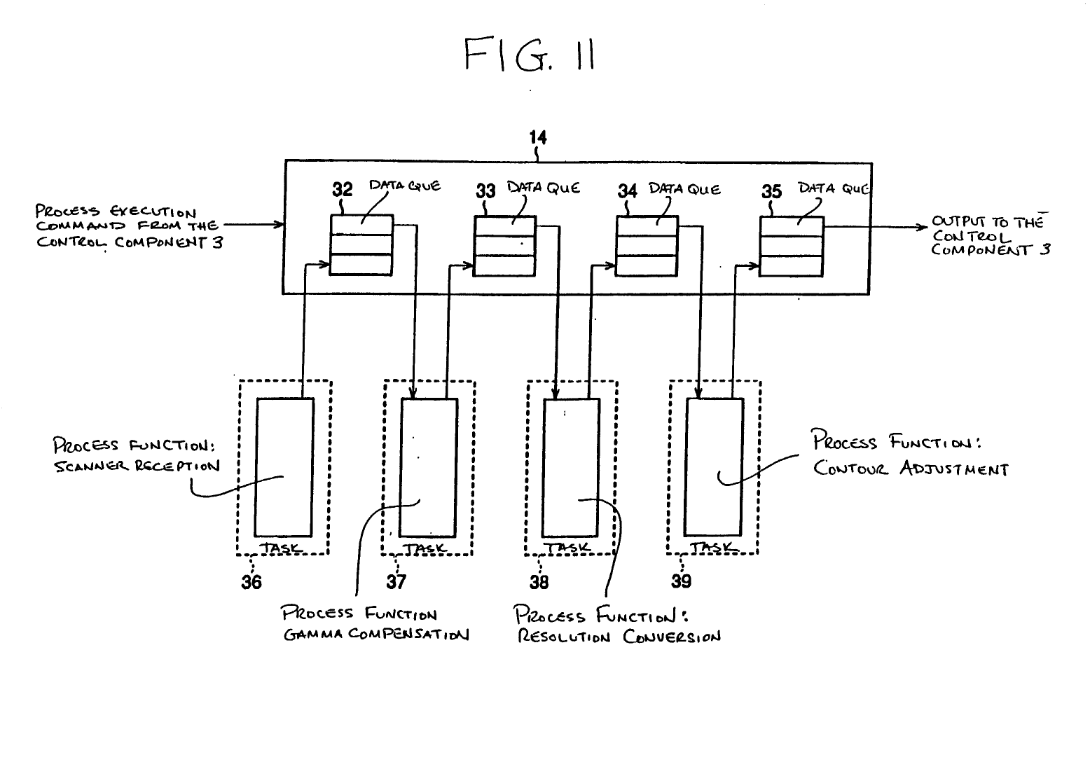

Next, a description of the method for executing the functions in the order set in the array variable will be given with reference to the operational flow chart of FIG. 10. First, in step S61, the value 1 is set for the variable i, and the variable MAX is set to the number of functions that are to be executed (in this example, 3). Next, in step S62, a determination is made as to whether the value of the variable i is smaller than the value of the variable MAX. If a determination is made that the value of the variable i is smaller than the value of the variable MAX, then the program proceeds to step S63. In step S63, the variable j is set to 0. The value of the variable j corresponds to the number of each element (indicated by an integer greater than 0) of the array variable 14a.

In step S64, a determination is made as to whether the value of the variable j is smaller than the value of the variable MAX. If a determination is made that the value of the variable j is smaller than the value of the variable MAX, then the program proceeds to step S65. In step S65, a determination is made as to whether the value of the picture image processing function that is set for the j-position of the array variable is the same as the value of the variable i. In the present example, the function in the j=0 (first) position of the array variable 14a is the gamma-compensation process (variable G). In the present case, since the value of the variable i is 1, and the value of the variable G is also 1, then a determination is made that the value of the variable i and the value of the variable registered in the j (=0) position (variable G) are the same, and the program proceeds to step S66.

In step S66, the function that is registered in the element in the j-position of the array variable 14a is executed. In this case, the function that corresponds to the address that is registered in the element in the j-position of the array variable 14a is the function that performs the gamma-compensation processing. Thus, the gamma-compensation processing is called and executed. When the process in step S66 is completed, the program proceeds to step S67. In step S67, the value of the variable j increases by 1. Therefore, the value of the variable j is reset to 1. The program then returns to step S64.

In step S64, a determination is again made as to whether the value of the variable j is smaller than the value of the variable MAX. Since the value of the variable j is 1, the value of the variable j is judged to be smaller than the value of the variable MAX and the program proceeds to step S65. In step S65, a determination is made as to whether the variable that corresponds to the picture image processing function that is registered in the element in the j-position of the array variable 14a is the same as the value of the variable i. In this case, since the value of the variable j is 1, a determination is made as to whether the value of the variable i and the value of the variable R that corresponds to the function that is registered in the array variable 14a in the j-position are the same. Since the value of the variable R is 2 and the value of the variable i is 1, a determination is made that the value of the variable R and the value of the variable i are not the same, and without performing any process, the program proceeds to step S67.

In step S67, the value of the variable j is increased by 1. Thus, the reset value of the variable j is 2. Next, the program returns to step S64. In step S64, a determination is made as to whether the value of the variable j is smaller than the value of the variable MAX. In this case, since the value of the variable j is 2, a determination is made that the value of the variable j is smaller than the value of the variable MAX, the program proceeds to step S65. In step S65, a determination is made as to whether the value that is assigned to the variable that corresponds to the function that is registered to the element in the j-position of the array variable 14a is the same as the value of the variable i.

In this case, since the value of the variable j is 2 and the variable that corresponds to the function that is registered to the element in the number 3 position of the array variable 14a is K, then a determination is made as to whether the value that is set for the variable K is the same as the value of the variable i. Since the value of the variable K is 3 and the value of the variable i is 1, a determination is made that the value of the variable K and the value of the variable i are not the same, and the program proceeds to step S67. In step S67, the value of the variable j is increased by 1. Consequently, the value of the variable j is now 3. Next, the program returns to step S64.

In step S64, a determination is made as to whether the value of the variable j is smaller than the value of the variable MAX. In the present case, since the value of the variable j is 3, a determination is made that the value of the variable j is not smaller than the value of the variable MAX, and the program proceeds to step S68. In step S68, the value of the variable i is increased by 1, so that the value of the variable i is 2. Next, the program then returns to step S62. In step S62, a determination is made as to whether the value of the variable i is smaller than the value of the variable MAX. In this case, a determination is made that the value of the variable i is smaller than the value of the variable MAX, and the program proceeds to step S63. In step S63, the value of the variable j is set to 0.

Next, in step S64, a determination is made as to whether the value of the variable j is smaller than the value of the variable MAX. In this case, since the value of the variable j is 0, a determination is made that the value of the variable j is smaller than the value of the variable MAX, and the program proceeds to step S65. In step S65, a determination is made as to whether the value that is set for the variable that corresponds to the function that is registered to the element in the j-position of the array variable 14a is the same as the value of the variable i. In this case, since the value of the variable G that corresponds to the function that is registered to the element in the j=0 position of the array variable 14a is 1 and the value of the variable i is 2, a determination is made that the value of the variable G is not the same as the value of the variable i. The program then proceeds to step S67. In step S67, the value of the variable j is increased by 1, resulting in j being set to 1. The program then returns to step S64.

In step S64, a determination is made as to whether the value of the variable j is smaller than the value of the variable MAX. In this case, since the value of the variable j is 1, a determination is made that the value of the variable j is smaller than the value of the variable MAX, and the program proceeds to step S65. In step S65, a determination is made as to whether the value that is set for the variable that corresponds to the function that is registered to the element in the j-position of the array variable 14a is the same as the value of the variable i. In this case, since the value of the variable is 2 and the value set for the variable R is 2, a determination is made that the value that is set for the variable R is the same as the value of the variable i. The program then proceeds to step S66. In step S66, the function that is registered to the element in the j-position of the array variable 14a is executed. In this case, since the value of the variable j is 1, the function that is registered to the element in the number 2 position of the array variable 14a is executed, namely, the function for performing the contour adjustment in the example of FIG. 9. The program then proceeds to step S67 where the value of j is increased to 2.

Next, the program returns to step S64. In step S64, a determination is made that the value of the variable j is smaller than the value of the variable MAX, therefore the program proceeds to step S65. In step S65, a determination is made as to whether the value that is set for the variable that corresponds to the function that is registered to the element in the j-position of the array variable 14a is the same as the value of the variable i. In this case, a determination is made that the value 3 of the variable K that corresponds to the function that is registered to the element in the j-position of the array variable 14a is not the same as the value of the variable i. The program then proceeds to step S67. In step S67, the value of the variable j increases by 1 and is reset to 3.

In the same manner as described above, the function for performing the resolution conversion processing that is registered to the element in the number 3 position (=2) of the array variable 14a is finally executed.

As a result, it is easy to change the execution order of the processing functions by resetting the variables that correspond to each function thereby executing the functions in the reset order.

Next, an explanation of the method for further raising the process efficiency will be provided by executing each of the aforementioned picture image processing functions in a multi-task environment. When entering picture image data from the scanner 5, the size of the picture image data typically ranges from 10 MB (mega Byte) to 200 MB. When attempting to read and process the entire amount of picture image data in one attempt, a large memory capacity is required. Therefore, the data is read after being divided into several portions, and the divided data is sequentially processed.

In a multi-task environment, each of the picture image processes are independent and operate in parallel. Furthermore, the data to be processed by each picture image process is saved in a data que. Accordingly, each of the picture image processes are read from the data que and the data is processed. The processing result is then saved again in the data que. Thus, it becomes possible to raise the process efficiency in a multi-task environment, since each of the picture image processes are independent and capable of operating in parallel.

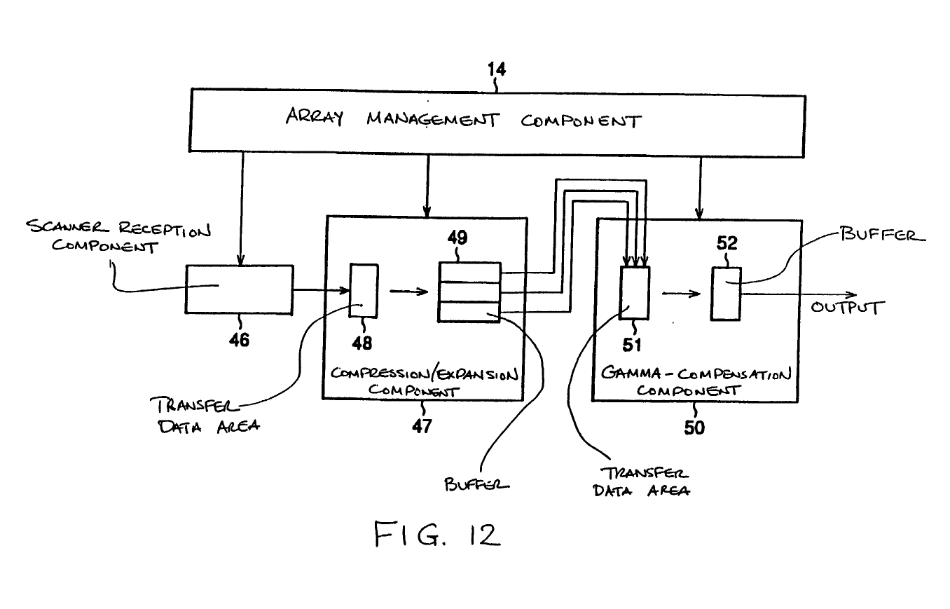

FIG. 11 is a block diagram showing a second embodiment of the invention. As shown, the picture image processing component 2, when executing the plurality of picture image processes, functions independently as well as in parallel. The array management component 14 provides a plurality of data ques and stores the processing data from each task in order to supply such processing data to the subsequent task. In the present example, the task 36 for executing the scanner reception processing function, the task 37 for executing the gamma-compensation processing function, the task 38 for executing the resolution conversion processing function, and the task 39 for executing the contour adjustment processing function, are all operated independently. In the present example, the processes are performed for the picture image data received from the scanner 5 in the order of task 36, task 37, task 38, and task 39.

First, the picture image data is received in sequence from the scanner 5 and is supplied to the data que 32 and stored. Next, task 37 reads the picture image data that is stored in the data que 32, and after gamma-compensation processing, supplies the data to the data que 33 where it is stored. Then, the task 38 reads the picture image data that is stored in the data que 33, and after resolution conversion processing, supplies the data to the data que 34 where it is stored. Task 39 reads the picture image data that is stored in the data que 34, and after contour adjustment processing, outputs the data through the data queue 35.

Each task is operated independently and in parallel, and the prescribed processes are performed for the data. The process results are then supplied to the prescribed data que, making it possible to move immediately to the processing of the next data. As a result, it becomes possible to raise the processing efficiency.

The embodiment described above may also be realized by using an object oriented language (for example, C++) with the described program. In this way, it becomes possible to create a program with an even greater ability for maintenance.

For instance, the units for each picture image to be processed can be provided as one class. Then, a fundamental class for the picture image processing is created and a fundamental interface for the processing routine is defined. Each of the picture images to be processed succeeds the aforementioned fundamental class. In addition, the array management component 14 calls the interface of the fundamental class.

A description will be provided hereafter regarding one method for improving the utility of the memory in the case of processing picture image data of a comparatively large size. In order to perform a series of picture image processing functions, the picture image data is transferred between each of the picture image processes. Since the efficiency progressively worsens when utilizing memory upon each transmission of a picture image, a transfer area of a prescribed size is used. Depending upon the picture image processing function, there are cases when the data size changes due to the picture image processing itself (for example, during the compression/expansion process). In this case, the data is divided, allowing transmission to take place over several intervals.

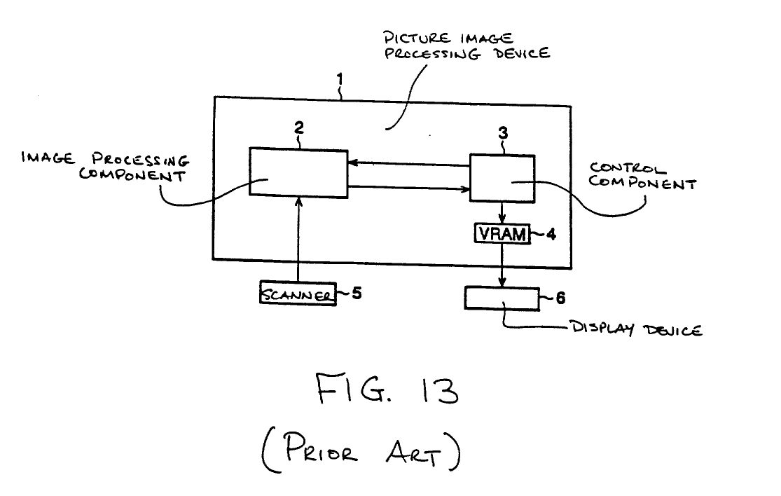

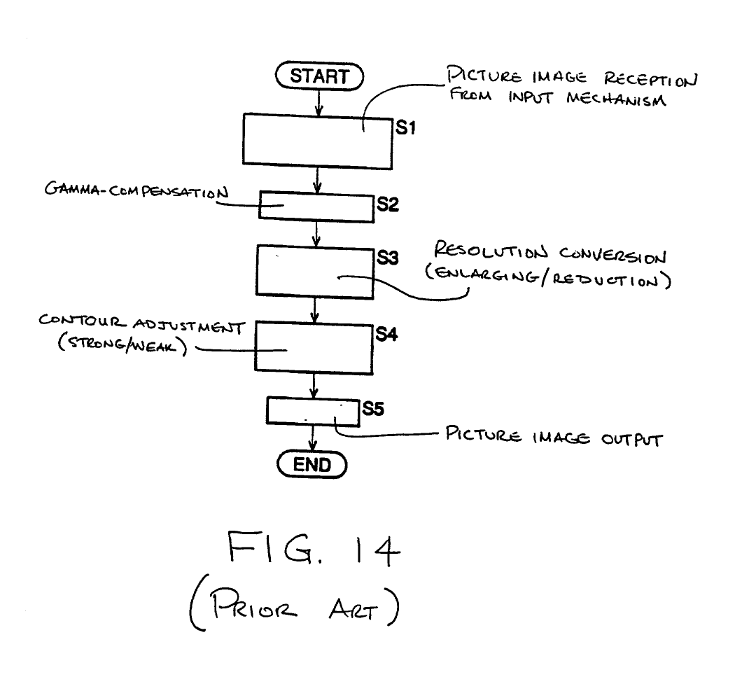

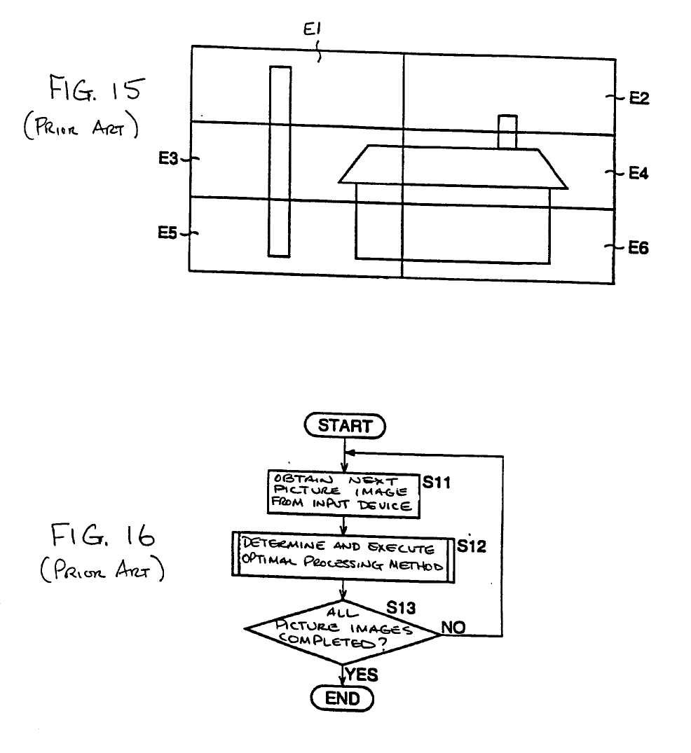

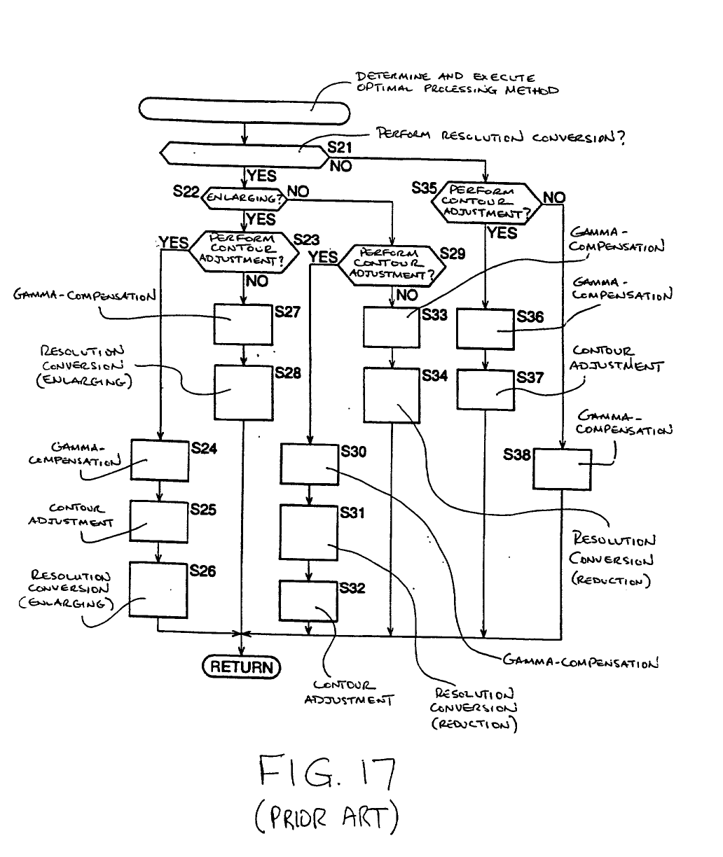

FIG. 12 is a block diagram showing another embodiment of the invention. A scanner reception component 46 receives and then outputs the picture image data from the scanner 5. A compression/expansion component 47 provides a buffer 49, which stores the post-processed data, and a transfer data area 48, which stores the transferred data. After performing the compression or the expansion process for the data that is stored in the transfer data area 48, the compression/expansion component 47 outputs this data through the buffer 49.

The gamma-compensation component 50 provides a buffer 52, which stores the post-processed data, and a transfer data area 51 which stores the transferred data. After performing the gamma-compensation processing for the data that is stored in the transfer data area 51, the gamma-compensation component 50 outputs this data through the buffer 52. The array management component 14 controls the operation of each component.

The picture image data that is received through the scanner reception component 46 is transferred to the compression/expansion component 47 and stored in the transfer data area 48. After performing, for example, the expansion process for the picture image data that is transferred to the transfer data area 48, the data is supplied to the buffer 49. At this time, the data size of the picture image data increased due to the performing of the expansion process.

From the picture image data that is stored in the buffer 49, a portion which is suited to the size of the transfer data area 51 of the gamma-compensation component 50 is transferred to the transfer data area 51 by way of the control of the array management component 14. Then, the gamma-compensation component 50 performs, by way of the control of the array management component 14, the gamma-compensation processing for the picture image data that was transferred to the transfer data area 51 and outputs, through the buffer 52, the picture image data that underwent gamma-compensation processing.

Next, by way of the control of the array management component 14, the compression/expansion component 47 transfers the next portion of data that is suited to the size of the transfer data area 51 from among the picture image data that is stored in the buffer 49, to the transfer data area 51. The gamma-compensation component 50, after performing gamma-compensation processing for the picture image data that was supplied to the transfer data area 51, outputs the picture image data that underwent gamma-compensation processing through the buffer 52. In this way, the picture image data remaining stored in the buffer 49 is transferred to the transfer data area 51 in turn, and is output after undergoing gamma-compensation processing.

In the embodiment described above, the program that performs each process of the picture image processing component 2 shown in the flow charts of FIGS. 2, 3 and 10 is capable of being stored in the ROM. This program may also be provided to the user in a prerecorded state on the aforementioned ROM, or it may be provided to the user in a state that is stored on a CD-ROM (compact disk-read only memory) so as to have the ability to be copied to the ROM. In this case, the ROM may include an EEPROM (electrically erasable and programmable read only memory) so that it has the ability to be written over electrically. The program also can be provided to the user over a communications network such as the Internet (World Wide Web).

In the embodiment described above, the picture image data is input from the scanner. However, the picture image data may also be input from another input device such as a CCD camera, or the like.

Further, in the embodiment described above, the present invention was applied to the situation of performing picture image processing in picture image data. However, the present invention may also be applied in the case of performing a prescribed process on audio sound data or some other data (for example, line drawing or other memo data).

According to the data processing apparatus described with respect to one embodiment of the invention, the first storage means stores one or more processes, and the second storage means stores information corresponding to each of the one or more processes. The setting means sets the order for executing the processes that correspond to the information that is stored in the second storage means, the replacement means replaces the order, and the execution means executes, in the order that is set by the setting means, the processes that correspond to the information that is stored in the second storage means in relation to the data. It then becomes possible to easily execute the desired processes in a desired order.

According to the data processing apparatus described with respect to a second embodiment of the invention, the execution means executes a plurality of processes, the first storage means stores first data that is the subject of execution for each process, and the second storage means stores second data that is the execution result for each process. The supply means supplies to the first storage means second data that is the result of one process and the prescribed object of some other process to which the second data is to be transferred next. The supply means splits the second data when the data amount of the second data resulting from the one process is larger than the data amount that is possible to be stored in the first storage means.

Furthermore, since the execution means executes the divided and supplied second data regardless of the size of the picture image data, the size of the first storage means can be made a fixed size, thereby making it is possible to improve the memory utility.

The invention is not limited to implementation by a programmed general purpose computer as shown in the preferred embodiment. For example, the invention can be implemented using one or more special purpose integrated circuit(s) (e.g., ASIC). It will be appreciated by those skilled in the art that the invention can also be implemented using one or more dedicated or programmable integrated or other electronic circuits or devices (e.g., hardwired electronic or logic circuits such as discrete element circuits, or programmable logic devices such as PLDs, PLAs, PALs or the like). In general, any device of assembly of devices on which a finite state machine capable of implementing the flow charts show in FIGS. 2, 3 and 10 can be used.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. A data processing apparatus for performing one or more of a plurality of processes on prescribed data in a specified order, comprising:
first storage means for storing said plurality of processes;
second storage means for storing information that corresponds to one or more of said plurality of processes;
setting means for setting an order for executing said processes, said order corresponding to said information stored in said second storage means;
replacement means for replacing said order for executing said processes; and
execution means for executing on said prescribed data, in the order set by said setting means, said processes that correspond to said information stored in said second storage means.

2. The data processing apparatus according to claim 1, wherein said information stored in said second storage means is an address in said first storage means where said process is stored.

3. The data processing apparatus according to claim 1, wherein the order for executing said processes set by said setting means is indicated by the order in which said information is stored in said second storage means.

4. The data processing apparatus according to claim 1, wherein the order for executing said processes set by said setting means is indicated by a number attached to each said process, said number corresponding to said information stored in said second storage means.

5. The data processing apparatus according to claim 1, further comprising addition means for adding new information, that corresponds to another process, to said information stored in said second storage means.

6. The data processing apparatus according to claim 1, wherein said plurality of types of processes include processes performed on picture image data.

7. The data processing apparatus according to claim 1, wherein said plurality of types of processes include processes performed on audio data.

8. In a data processing apparatus that performs a plurality of types of processes in a prescribed order on prescribed data, the data processing apparatus comprising:
a plurality of execution means for executing a plurality of types of processes;
first storage means for storing first data as an execution subject of each process;
second storage means for storing second data as an execution result of each process;
supply means for, when the amount of the second data resulting from execution of one of said plurality of types of processes exceeds a maximum amount of data that can be stored by said first storage means, dividing said second data into plural portions for supply to said first storage means; and
said execution means to which the plural portions are supplied sequentially executes said divided and supplied plural portions of second data supplied by the supply means.

9. The data processing apparatus according to claim 8, wherein said plurality of types of processes include processes performed on picture image data.

10. The data processing apparatus according to claim 8, wherein said plurality of types of processes include processes performed on audio data.

11. A recording medium that stores a computer-readable control program having instructions that are executable by a data processing apparatus to perform the steps of:
storing a plurality of processes for execution on prescribed data in a first memory area;
storing information that corresponds to one or more of the plurality of processes in a second memory area;
adjustably setting an order for executing one or more of the plurality of processes, said order corresponding to said information stored in the second memory area; and
executing, in the order that was set, said one or more processes that correspond to the information stored in the second memory area.

12. A data processing apparatus for performing one or more of a plurality of processes on prescribed data in a specified order, comprising:
a first memory area that stores said plurality of processes;
a second memory area that stores information that corresponds to one or more of said plurality of processes; and
a controller that adjustably sets an order for executing said one or more processes, said order corresponding to said information stored in said second memory area, said controller executing on said prescribed data, in the order that was set, said one or more processes that correspond to said information stored in said second memory area.

13. The data processing apparatus according to claim 12, wherein said information stored in the second memory area is an address in said first memory area where said process is stored.

14. The data processing apparatus according to claim 12, wherein the order for executing said processes that is set by said controller is indicated by the order in which said information is stored in said second memory area.

15. The data processing apparatus according to claim 12, wherein the order for executing said processes set by said controller is indicated by a number attached to each said process, said number corresponding to said information stored in said second memory area.

16. The data processing apparatus according to claim 12, wherein said controller adds new information that corresponds to another process to said information that is stored in said second memory area.

17. The data processing apparatus according to claim 12, wherein said plurality of types of processes comprise processes performed on picture image data.

18. The data processing apparatus according to claim 12, wherein said plurality of types of processes comprise processes performed on audio data.

19. In a data processing apparatus that performs a plurality of types of processes in a prescribed order on prescribed data, the data processing apparatus comprising:
a controller that executes a plurality of types of processes on the prescribed data;
a first memory area that stores first data as an execution subject of each process;
a buffer memory that stores second data as an execution result of each process; and wherein
said controller, when the amount of the second data resulting from execution of one of said plurality of types of processes exceeds a maximum amount of data that can be stored by said first memory area, divides the second data into a plurality of portions that are stored in said buffer memory and sequentially supplies said divided plural portions of second data to the first memory area for execution.

20. The data processing apparatus according to claim 19, wherein said plurality of types of processes include processes performed on picture image data.

21. The data processing apparatus according to claim 19, wherein said plurality of types of processes include processes performed on audio data.

22. A method for performing one or more of a plurality of processes on prescribed data in a specified order, comprising the steps of:
storing said plurality of processes;
storing information that corresponds to one or more of said plurality of processes;
adjustably setting an order for executing said processes, said order corresponding to said stored information; and
executing on said prescribed data, in the order that was set, said processes that correspond to said stored information.

23. The method according to claim 22, wherein said stored information is an address where the process is stored.

24. The method according to claim 22, wherein the order for executing said process is set by storing as said information, the order in which said information is to be executed.

25. The method according to claim 22, wherein the order for executing said processes is indicated by a number attached to each said process, said number corresponding to the stored information.

26. The method according to claim 22, further comprising adding new information, that corresponds to another process, to said stored information.

27. The method according to claim 22, wherein said plurality of types of processes include processes performed on picture image data.

28. The method according to claim 29, wherein said plurality of types of processes include processes performed on audio data.

29. A method for performing a plurality of types of processes in a prescribed order on prescribed data, comprises the steps of:
storing first data as an execution subject of each process;
storing second data as an execution result of each process;
when the amount of the second data resulting from execution of one of said plurality of types of processes exceeds a maximum amount of data that can be stored as said first data, dividing said second data into plural portions; and
sequentially supplying said plural portions as said first data for execution by a next process, and executing said plurality of types of processes.

30. The method according to claim 29, wherein said plurality of types of processes include processes performed on picture image data.

31. The method according to claim 29, wherein said plurality of types of processes include processes performed on audio sound data.
